(19) United States
(12) Patent Application Publication
(10) Pub. No.: US 2022/0043379 A1
(43) Pub. Date: Feb. 10, 2022

(54) HEATING DEVICE

(71) Applicant: TOSHIBA TEC KABUSHIKI KAISHA, Tokyo (JP)

(72) Inventor: Sasuke ENDO, Chigasaki Kanagawa (JP)

(21) Appl. No.: 17/319,549

(22) Filed: May 13, 2021

(30) Foreign Application Priority Data
Aug. 7, 2020 (JP) 2020-134739

(51) Int. Cl. G03G 15/20

(52) U.S. Cl. CPC G03G 15/2042; G03G 15/2032; G03G 2215/2035; G03G 15/2053; G03G 15/205

(57) ABSTRACT

In one embodiment, a heating device includes a tubular body and a heater within an interior region formed by the tubular body. A first temperature detector is disposed within the interior region. A first wire is connected to the first temperature detector on a first side of the first temperature detector facing a first direction parallel to the axial length of the tubular body. A second temperature detector is disposed within the interior region on a second side of the first temperature detector opposite the first side. The second temperature detector is spaced from the first temperature detector in a second direction opposite of the first direction. A second wire is connected to the second temperature detector on a side of the second temperature detector facing the second direction. The first wire and the second wire extend with each other to an outer end of the tubular body.

### CROSS-REFERENCE TO RELATED APPLICATION

This application is based upon and claims the benefit of priority from Japanese Patent Application No. 2020-134739, filed Aug. 7, 2020, the entire contents of which are incorporated herein by reference.

### FIELD

Embodiments described herein relate generally to a heating device for use in an image processing apparatus or the like.

### BACKGROUND

In the related art, a fixing device using a cylindrical belt or drum is used in an image processing apparatus. The fixing device includes a temperature detection unit and a conductive wire. The temperature detection unit detects the temperature of the belt or drum. The conductive wire is connected to the temperature detection unit. The conductive wire is used to output the temperature as detected by the temperature detection unit to the outside of the fixing device.

The assembly work required for attaching the temperature detection unit to the inside of the fixing device and then guiding the conductive wire within the fixing device can be performed manually. There is a case in the related where the fixing device includes a plurality of temperature detection units. For example, the plurality of temperature detection units are arranged side by side along the axial direction of the cylinder or drum.

However, if the fixing device is designed in this manner, there is a concern that the temperature detection units might be attached at the wrong positions within the fixing device during assembly.

### BRIEF DESCRIPTION OF THE DRAWINGS

FIG. 1 is a schematic configuration diagram of an image forming apparatus in which a fixing device of an embodiment can be used.

FIG. 2 depicts aspects related to a hardware configuration of an image forming apparatus.

FIG. 3 is a cross-sectional view of a fixing device.

FIG. 4 is a diagram illustrating an arrangement of a heating element group, a wiring group, a temperature detection unit on a substrate.

FIG. 5 is an enlarged view of a heater unit.

FIG. 6 is a diagram illustrating aspects of an arrangement of a temperature detection unit and a conductive wire for a heater unit.

FIG. 7 is a diagram illustrating a configuration of a first temperature detection unit.

FIG. 8 is a diagram illustrating an arrangement of a temperature detection unit and a conductive wire for a heater unit in a fixing device of a Comparative Example 1.

FIG. 9 is a diagram illustrating an arrangement of a temperature detection unit and a conductive wire for a heater unit in a fixing device of a Comparative Example 2.

FIG. 10 is a cross-sectional view of a fixing device of a first modification of an embodiment.

FIG. 11 depicts aspects of a fixing device of a second modification of an embodiment.

### DETAILED DESCRIPTION

Embodiments provide a fixing device that helps prevent a temperature detection unit from being attached to the wrong position during assembly or the like.

In general, according to one embodiment, a heating device, includes a tubular body, such as cylindrical belt or the like. A heater is disposed within an interior region surrounded by the tubular body. A first temperature detection unit is disposed within the interior region. A first conductive wire is connected to the first temperature detection unit on a first side of the first temperature detection unit facing a first direction parallel to the axial length of the tubular body. A second temperature detection unit is disposed within the interior region on a second side of the first temperature detection unit opposite the first side. The second temperature detection unit is spaced from the first temperature detection unit in a second direction opposite of the first direction. A second conductive wire is connected to the second temperature detection unit on a side of the second temperature detection unit facing the second direction. The first conductive wire and the second conductive wire extend with each other in the second direction to an outer end of the tubular body in the second direction.

Hereinafter, heating devices according to example embodiment will be described with reference to the drawings.

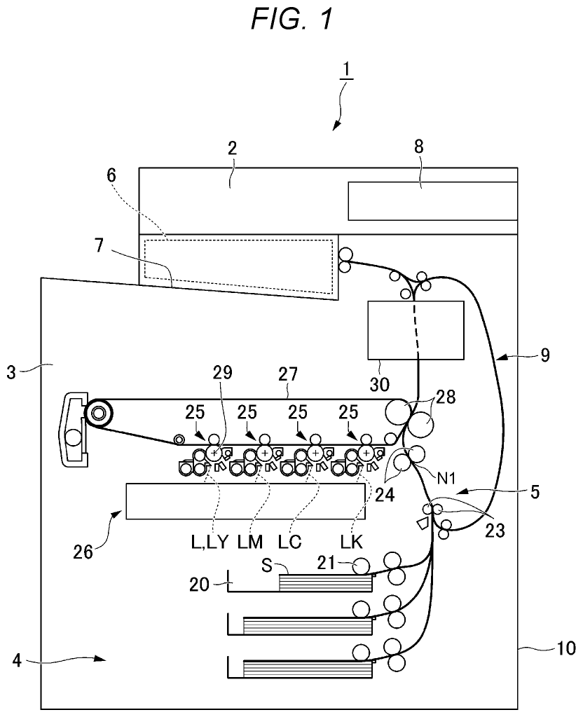

FIG. 1 is a schematic configuration diagram of an image forming apparatus 1, which is one example of an image processing apparatus according to an embodiment.

As illustrated in FIG. 1, a fixing device) 30 is used in the image forming apparatus 1. The fixing device 30 is one example of a heating device according to an embodiment. The image forming apparatus 1 performs processing for forming an image on a sheet S. The sheet S may be paper, for example. The image forming apparatus 1 includes a housing 10, a scanner unit 2, an image forming unit 3, a sheet supply unit 4, a conveyance unit 5, a sheet discharge tray 7, a reversing unit 9, a control panel 8, and a control unit 6.

The housing 10 forms the outer shape of the image forming apparatus 1.

The scanner unit 2 reads image information of an object (e.g., document) to be copied based on the brightness and darkness of reflected light and generates an image signal accordingly. The scanner unit 2 outputs the generated image signal to the image forming unit 3.

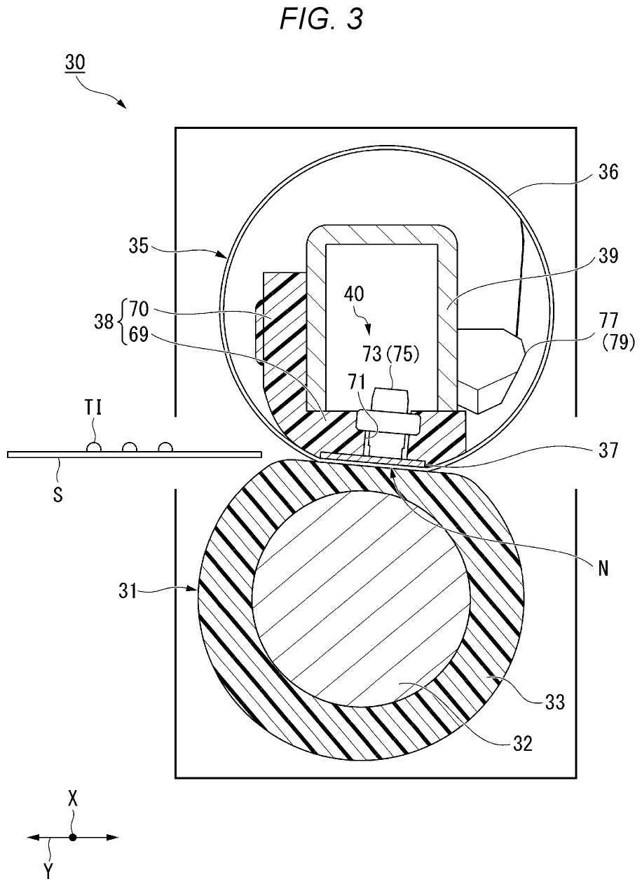

The image forming unit 3 outputs a toner image TI (see FIG. 3), or an image printed with another recording agent material, based on the image signal received from the scanner unit 2 or an image signal received from the outside of the image forming apparatus. The image forming unit 3 transfers the toner image TI onto the surface of the sheet S. The image forming unit 3 heats and presses the toner image TI on the surface of the sheet S to fix the toner image TI onto the sheet S.

The sheet supply unit 4 supplies the sheets S one by one to the conveyance unit 5 at a timing corresponding to when the image forming unit 3 forms the toner image TI. The sheet supply unit 4 includes a sheet storage unit 20 and a pickup roller 21.

The sheet storage unit 20 stores sheets S of a predetermined size and type.

The pickup roller 21 picks up the sheets S one by one from the sheet storage unit 20. The pickup roller 21 supplies the picked-up sheet S to the conveyance unit 5.

The conveyance unit 5 conveys the sheet S from the sheet supply unit 4 to the image forming unit 3. The conveyance unit 5 includes conveyance rollers 23 and registration rollers 24.

The conveyance rollers 23 convey the sheet S from the pickup roller 21 to the registration rollers 24. The conveyance rollers 23 makes the leading end of the sheet S in a second direction, in which the sheet is conveyed, abut against a nip N1 formed by the registration rollers 24.

The registration rollers 24 bend the sheet S at the nip N1 to adjust the position of the leading end of the sheet S. The registration rollers 24 then convey the sheet S according to the timing at which the image forming unit 3 can appropriately transfer the toner image TI to the sheet S.

The image forming unit 3 includes a plurality of image forming units 25, a laser scanning unit 26, an intermediate transfer belt 27, a transfer unit 28, and a fixing device 30.

Each image forming unit 25 includes a photoconductor drum 29. The image forming unit 25 forms a toner image TI corresponding to the image signal (from the scanner unit 2 or the outside) on the photoconductor drum 29. The plurality of image forming units 25 in this example form toner images TI with yellow toner, magenta toner, cyan toner, and black toner, respectively.

An electrostatic charger, a developing device, and the like are arranged around each photoconductor drum 29. The electrostatic charger charges the surface of the photoconductor drum 29. The developing device contains a developer with one of the yellow, magenta, cyan, or black toners. The developing device develops the electrostatic latent image that has been formed on the photoconductor drum 29. As a result, the toner image TI is formed on the photoconductor drum 29.

The laser scanning unit 26 scans the charged photoconductor drums 29 with a laser beam L to selectively expose the photoconductor drums 29 according to the image signal. The laser scanning unit 26 exposes the photoconductor drum 29 of the respective image forming units 25 for each color with different laser beams LY, LM, LC, and LK. Accordingly, the laser scanning unit 26 forms an electrostatic latent image on each photoconductor drum 29.

The toner image TI on the surface of the photoconductor drum 29 is then transferred to the intermediate transfer belt 27 (a primary transfer step).

The transfer unit 28 then transfers the toner images TI from the intermediate transfer belt 27 onto the surface of the sheet S at a secondary transfer position.

The fixing device 30 heats and press the toner image TI that has been transferred to the sheet S so as to fix the toner image TI to the sheet S.

The reversing unit 9 operates to reverse the sheet S to permit an image to be formed on the back surface of the sheet S. The reversing unit 9 reverses a sheet S discharged from the fixing device 30 by a switchback. The reversing unit 9 then conveys the reversed sheet S back towards the registration rollers 24.

A discharged sheet S having the image formed thereon can be placed on the sheet discharge tray 7.

The control panel 8 is apart of an input unit through which an operator inputs information for operating the image forming apparatus 1. The control panel 8 includes a touch panel and various hard keys.

The control unit 6 is a controller that controls the various units of the image forming apparatus 1.

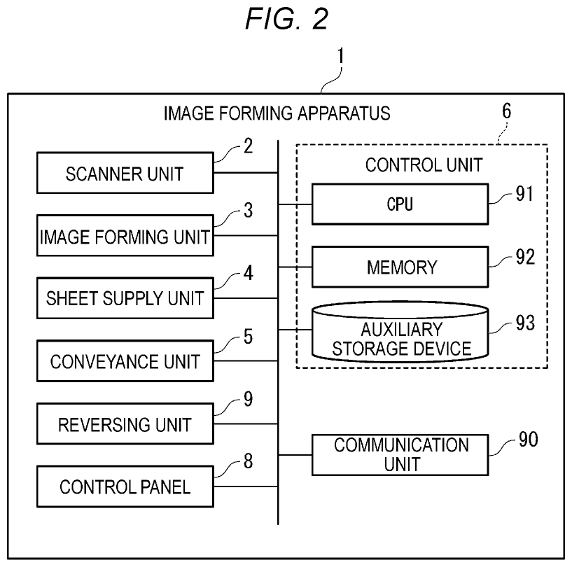

FIG. 2 is a hardware configuration diagram of an image forming apparatus 1.

As illustrated in FIG. 2, the image forming apparatus 1 includes a central processing unit (CPU) 91, a memory 92, an auxiliary storage device 93, and the like, which are connected to each other by a bus. The CPU 91 executes programs and thus provides various functions including the functions of a scanner unit 2, an image forming unit 3, a sheet supply unit 4, a conveyance unit 5, a reversing unit 9, a control panel 8, and a communication unit 90.

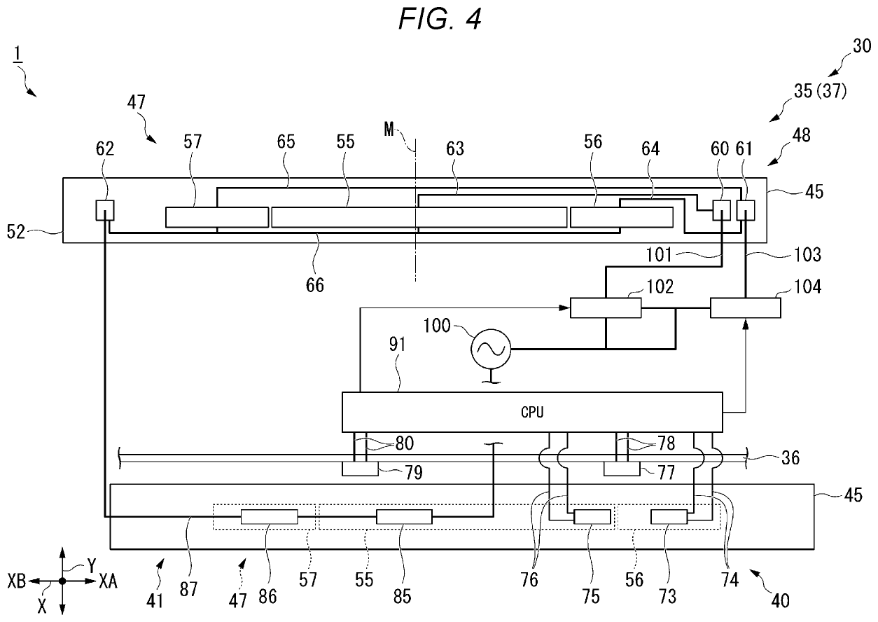

Conductive wires 74, 76, 78, and 80 (see FIG. 4) in the fixing device 30 can be connected via a first connector to the bus.

In general, the CPU 91 functions as the control unit 6 (controller) by executing programs stored in the memory 92 and/or the auxiliary storage device 93. The control unit 6 controls the overall operations of each functional unit of the image forming apparatus 1.

The auxiliary storage device 93 can be a storage device such as a magnetic hard disk device (HDD) or a semiconductor storage device (SSD). The auxiliary storage device 93 stores information.

The communication unit 90 includes a communication interface for connecting to an external device. The communication unit 90 communicates with an external device via the communication interface.

FIG. 3 is a cross-sectional view of the fixing device 30 of an embodiment. FIG. 3 is a cross-sectional view of the fixing device 30 taken at the center (in a first direction X) portion of the heater unit 37. The fixing device 30 includes a pressure roller 31 and a film unit 35.

The pressure roller 31 forms a nip N with the film unit 35. The pressure roller 31 presses the toner image TI on the sheet S in the nip N. The pressure roller 31 rotates to convey the sheet S. The pressure roller 31 includes a cored bar 32, an elastic layer 33, and a release layer (not separately illustrated).

The cored bar 32 is formed in a columnar or rod shape with a metal such as stainless steel. Both ends of the cored bar 32 in the axial direction are rotatably supported by a bearing or the like. The cored bar 32 can be rotationally driven by a motor. The cored bar 32 abuts against a cam member or the like which provides an abutting and releasing mechanism. For example, the cam member rotates to move the cored bar 32 towards and away from the film unit 35.

The elastic layer 33 is made of an elastic material such as silicone rubber. In this example, the elastic layer 33 is formed with a constant thickness on the outer peripheral surface of the cored bar 32.

The release layer is made of a resin material such as tetrafluoroethylene/perfluoroalkyl vinyl ether copolymer (PFA). The release layer is formed on the outer peripheral surface of the elastic layer 33.

The pressure roller 31 is configured as follows, for example. The cored bar 32 is made of stainless steel and has an outer diameter of 14 mm. The elastic layer 33 is formed by injection-molding silicone rubber onto the outer peripheral surface of the cored bar 32. The thickness of the elastic layer 33 is 8 mm. The release layer is made of PFA and has a thickness of 30 μm (micrometers). The outer diameter of the pressure roller 31 is 30 mm. The length of the elastic layer 33 along the axial direction is 332 mm.

The hardness of the outer peripheral surface of the pressure roller 31 is desirably 40° to 70° as measured with an ASKER-C hardness tester under a load of 9.8 N (newtons). Accordingly, the area of the nip N and the durability of the pressure roller 31 are ensured. For example, in this embodiment, the hardness of the outer peripheral surface of the pressure roller 31 is 60°.

As noted, the pressure roller 31 can move towards and away from the film unit 35 by the rotation of the cam member. When the pressure roller 31 is moved toward the film unit 35 and pressed by a pressing spring, the nip N is formed. This is an abutting state where the pressure roller 31 abuts against the film unit 35. In the abutting state, the pressure of the nip N is a pressure at which the fixing operation is possible.

However, if the sheet S becomes jammed in the fixing device 30, the sheet S can be removed by moving the pressure roller 31 away from the film unit 35. This is a separated state where the pressure roller 31 is separated from the film unit 35. The pressure at the nip N in the separated state is less than in the abutting state.

In a device state in which the tubular film 36 will not be rotating, such as during a device sleep or idle state, the pressure roller 31 can be moved away from the film unit 35 to prevent plastic deformation of the tubular film 36.

The fixing device 30 can be switched between the abutting state and the separated state by rotation of the cam mechanism or the like.

For example, the overall pressing force between the pressure roller 31 and the film unit 35 when the pressure spring is engaged is preferably 400 N.

The pressure roller 31 is driven by a motor to rotate. The pressure roller 31 may be rotationally driven by a motor through a gear train or the like.

When the pressure roller 31 rotates while the nip N is formed, the tubular film 36 of the film unit 35 is also driven to rotate. The pressure roller 31 conveys the sheet S in a second direction Y by rotating with the sheet S in the nip N.

The film unit 35 heats the toner image TI on the sheet S that entered the nip N. As illustrated in FIGS. 3 and 4, the film unit 35 includes the tubular film 36, the heater unit 37, a support member 38, a stay 39, a temperature detection unit 40, and a temperature switch unit 41. In FIG. 4, two substrates 45 are illustrated, but this is to more clearly show the positions of the heater unit 37 and the like on the singular substrate 45 of the film unit 35.

As illustrated in FIG. 3, the tubular film 36 is formed in a cylindrical shape. The tubular film 36 includes a base layer, an elastic layer, and a release layer in order from the inner circumferential side. The base layer is formed by a resin such as polyimide, or a metal such as nickel or stainless steel. The elastic layer is laminated on the outer peripheral surface of the base layer. The elastic layer is made of an elastic material such as silicone rubber. The release layer is laminated on the outer peripheral surface of the elastic layer. The release layer is made of a material such as PFA resin.

In order to shorten the warming-up time required to heat the fixing device 30 to a predetermined temperature, it is preferable that the heat capacity of the elastic layer and the release layer is not very large. It is preferable that the thickness of the elastic layer and the thickness of the release layer are set such that the heat capacity of the elastic layer and the release layer is not very large.

For example, the inner diameter of the tubular film 36 is approximately 30 mm. The base layer is made of nickel with a thickness of 40 μm. The elastic layer is made of silicone rubber with a thickness of 200 μm. The release layer is made of PFA resin with a thickness of 30 μm.

The inner surface of the base layer in the radial direction may be coated with a lubricant or the like to improve the frictional sliding properties. A heat-stable grease or the like may be applied to the inner peripheral surface of the tubular film 36. Such a configuration can enhance the sliding properties (reduce friction) between the tubular film 36 and the heater unit 37.

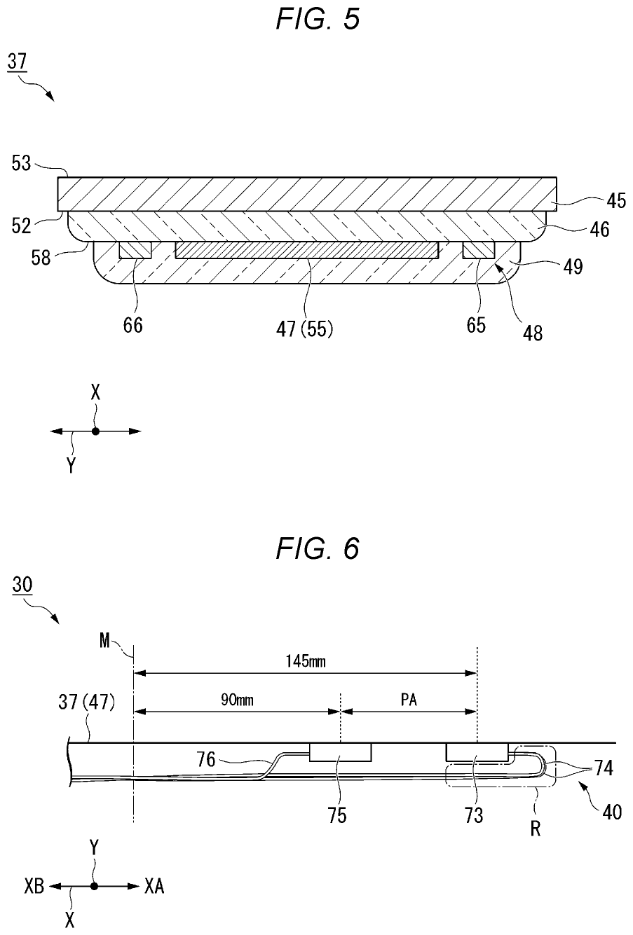

As illustrated in FIGS. 4 and 5, the heater unit 37 includes a substrate 45, a glass layer 46, a heating element group 47 (also referred to as a heater 47), a wiring group 48, and a glass coating 49.

The substrate 45 is made of a metal material such as stainless steel or a ceramic material such as aluminum nitride. The substrate 45 is formed in an elongated rectangular plate shape. In the following, the surface on a first side of the substrate 45 is called a first surface 52. A surface of the substrate 45 on a second side opposite to the first side is called a second surface 53.

The substrate 45 is disposed inside the region surrounded by the tubular film 36 (region inside the tubular film 36 in the radial direction). The substrate 45 extends in a first direction X parallel to the axial length of the tubular film 36. A holder can be fixed to or mounted on the second surface 53 of the substrate 45.

The glass layer 46 has electrical insulation properties and covers the first surface 52 of the substrate 45.

The heating element group 47 includes a first heater 55, a second heater 56, and a third heater 57.

The heaters 55, 56, and 57 are heating resistors formed in a rectangular plate shape. As illustrated in FIG. 4, the second heater 56 is disposed to a first end XA side of the first heater 55. The third heater 57 is disposed to the second end XB side (the second end XB is opposite to the first end XA along the first direction X) of the first heater 55. In other words, the second heater 56, the first heater 55, and the third heater 57 are arranged in this order from the first end XA to the second end XB along the first direction X. In FIG. 4, the centerline (midpoint) of the heating element group 47 (which is also the centerline for heater unit 37) along the first direction X is indicated by M.

The resistance value of the second heater 56 and the resistance value of the third heater 57 are substantially equal to each other. The resistance value of the first heater 55 is less than the resistance value of the second heater 56 and thus also less than the resistance value of the third heater 57.

As illustrated in FIG. 5, the heaters 55, 56, and 57 are arranged on the first surface 58, which is the surface opposite to the substrate 45 within the glass layer 46. The heaters 55, 56, and 57 can be formed on the glass layer 46 by screen-printing silver, palladium alloy, silver-palladium alloy, or the like.

The heaters 55, 56, and 57 are each arranged inside the region surrounded by the tubular film 36.

As illustrated in FIG. 4, the wiring group 48 includes a first contact 60, a second contact 61, a third contact 62, a first conductor 63, second conductors 64 and 65, and a third conductor 66.

In this embodiment, the contacts 60 and 61 are disposed to the first end XA side of the second heater 56 on the first surface 58 of the glass layer 46. The third contact 62 is disposed to the second end XB side of the third heater 57 X on the first surface 58 of the glass layer 46.

The conductive wires 63, 64, 65, and 66 are each formed in a substantially linear form.

The first conductor 63 is connected to the first contact 60 and the first heater 55. The second conductor 64 is connected to the second contact 61 and the second heater 56. The second conductor 65 is connected to the second contact 61 and the third heater 57. The third conductor 66 is connected to the third contact 62 and the heaters 55, 56, and 57, respectively.

The conductors 63, 64, 65, and 66 are arranged on the first surface 58 of the glass layer 46.

The contacts 60, 61, and 62, and the conductors 63, 64, 65, and 66 are formed on the glass layer 46 by screen-printing silver or the like.

The heaters 56 and 57 are connected to each other in parallel. The first heater 55 and the heaters 56 and 57 can be controlled independently of each other.

It is preferable that the ratio of the resistance value between the first heater 55 and the resistance value of the heaters 56 and 57 as a whole is in the range of 1:3 to 1:7. It is preferable that the ratio between the resistance value of the first heater 55 and the resistance value of the heaters 56 and 57 as a whole is in the range of 1:4 to 1:6.

As illustrated in FIG. 5, the glass coating 49 is disposed on the first surface 58 of the glass layer 46. The glass coating 49 covers the heating element group 47 and the wiring group 48. The glass coating 49 protects the heating element group 47 and the like. The glass coating 49 enhances the sliding properties of the tubular film 36 and the heater unit 37.

The heater unit 37 is disposed such that the glass coating 49 comes into contact with the inner surface of tubular film 36 in the radial direction.

As illustrated in FIG. 3, the support member 38 includes a first member 69 and a second member 70. The members 69 and 70 are formed in an elongated rectangular plate shape. The members 69 and 70 extend in the first direction X. A plurality of through holes 71 are formed in the first member 69 at intervals from each other in the first direction X. One of the plurality of through holes 71 is illustrated in FIG. 3.

The surface on the first side of the first member 69 in the thickness direction is fixed to the heater unit 37 from the inside of the tubular film 36 in the radial direction. The first member 69 is fixed to the surface (second surface 53) on the substrate 45 side in the heater unit 37.

The second member 70 extends from the end portion of the first member 69 in the width direction (second direction Y) towards the thickness direction of the first member 69 in a direction of moving away from the heater unit 37. The support member 38 is gutter-shaped (V-shaped) when viewed in the first direction X. The support member 38 is a member having rigidity, heat-resistance, and heat-insulating properties. The support member 38 is made of resin materials such as silicone rubber, fluororubber, polyimide resin, polyphenylene sulfide (PPS), polyethersulfone (PES), and liquid crystal polymer.

The support member 38 supports the inner peripheral surface of the tubular film 36 at both end portions in the second direction Y.

The stay 39 is made of steel plate material or the like. The stay 39 extends in the first direction X. The cross section of the stay 39 perpendicular to the first direction X is U-shaped. The stay 39 has a U-shaped opening portion that is closed by the first member 69 of the support member 38. The stay 39 is fixed to the surface opposite to the heater unit 37 in the first member 69. Both end portions of the stay 39 in the first direction X are fixed to the housing 10 of the image forming apparatus 1. Accordingly, the film unit 35 is supported by the image forming apparatus 1. The stay 39 improves the bending rigidity of the film unit 35.

For example, the stay 39 is formed by bending a steel plate with a thickness of 2.0 mm. A flange or the like can be mounted in the near the end portions of the stay 39 in the first direction X to restrict the movement of the tubular film 36.

As illustrated in FIGS. 4 and 6, the temperature detection unit 40 includes a first temperature detection unit 73, the first conductive wire 74, a second temperature detection unit 75, the second conductive wire 76, a third temperature detection unit 77, the third conductive wire 78, a fourth temperature detection unit 79, and the fourth conductive wire 80. The first temperature detection unit 73, the second temperature detection unit 75, the third temperature detection unit 77, and the fourth temperature detection unit 79 are temperature detection units.

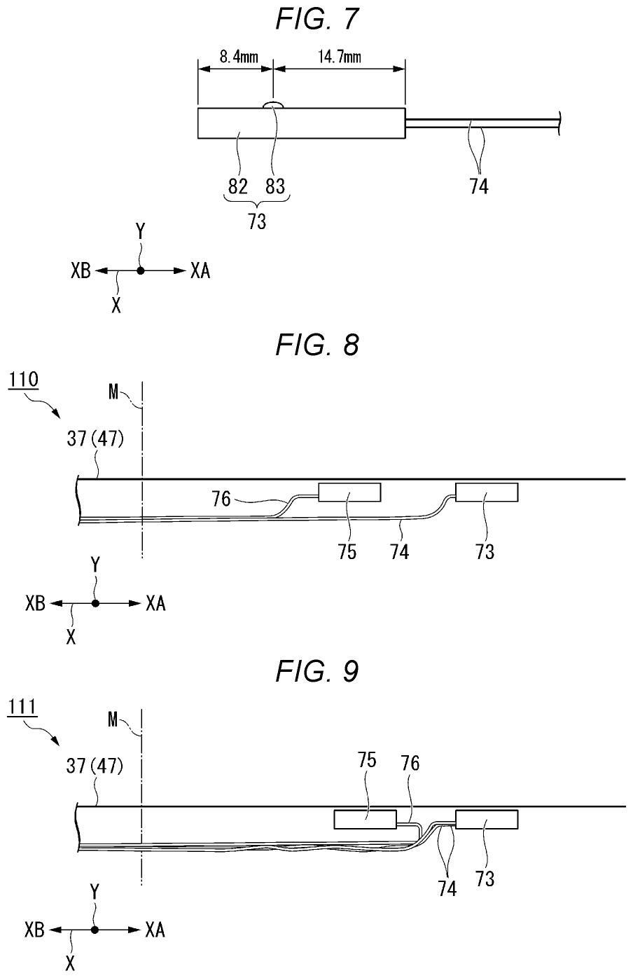

For example, thermistors are used for the temperature detection units 73, 75, 77, and 79. For example, as illustrated in FIG. 7, the first temperature detection unit 73 includes a case 82 and a temperature sensing unit 83. The case 82 is formed in a rectangular shape long in the first direction X. The temperature sensing unit 83 is disposed at the middle portion of the case 82 in the first direction X. The temperature sensing unit 83 protrudes outward from the case 82.

The surface of the first conductive wire 74 is provided with an electrically insulating coating. Two first conductive wires 74 are connected to the first temperature detection unit 73. The two first conductive wires 74 are connected to the first temperature detection unit 73 from the first end XA of the first temperature detection unit 73. That is, the end portion connected to the first temperature detection unit 73 in the first conductive wire 74 is disposed on the first end XA of the first temperature detection unit 73. For example, the length along the first direction X from the center of the temperature sensing unit 83 to the first end XA of the case 82 is 14.7 mm. The length along the first direction X from the center of the temperature sensing unit 83 to the second end XB of the case 82 in the first direction X is 8.4 mm.

The first temperature detection unit 73 outputs the temperature detected by the temperature sensing unit 83 as a difference in potential between the two first conductive wires 74.

As illustrated in FIG. 6, the first conductive wire 74 protruding from the first temperature detection unit 73 toward the first end XA is folded back toward the second end XB.

The first temperature detection unit 73 is disposed the first end XA of the heating element group 47. For example, the first end XA (an end portion) of the heating element group 47 refers to a positional range of 20% of the total length of the heating element group 47 along the first direction X from the very tip end on the first end XA of the heating element group 47 back towards the second end XB.

As illustrated in FIG. 3, a part of the first temperature detection unit 73 is disposed in the through hole 71 of the support member 38 and connected to the holder of the heater unit 37. The first temperature detection unit 73 is in contact with the heater unit 37.

In the first temperature detection unit 73, a thermistor element may be disposed through ceramic paper or the like. Such a configuration can stabilize the state where the first temperature detection unit 73 comes into contact with the heater unit 37. The first temperature detection unit 73 may be coated with an insulating material such as polyimide.

The temperature detection units 75, 77, and 79 have the same configuration as that of the first temperature detection unit 73. The conductive wires 76, 78, and 80 have the same configuration as that of the first conductive wire 74.

As illustrated in FIG. 6, the second temperature detection unit 75 is disposed at the center portion of the heating element group 47 in the first direction X. For example, the central portion of the heating element group 47 refers to a part of the heating element group 47 other than the end portions on the first end XA side and the end portion on the second end XB side.

In other words, the second temperature detection unit 75 is offset to the second end XB side of the first temperature detection unit 73 in the first direction X, and to the first end XA side of the centerline M in the first direction X. The temperature detection units 73 and 75 are each disposed inside the region surrounded by tubular film 36. The temperature detection units 73 and 75 respectively detect the temperature of the heater unit 37.

The second conductive wires 76 are connected to the second temperature detection unit 75 from the second side XB of the second temperature detection unit 75 in the first direction X. That is, the end portion connected to the second temperature detection unit 75 in the second conductive wire 76 is disposed on the second side XB of the second temperature detection unit 75. The second conductive wire 76 is not folded back inside the tubular film 36. The second conductive wire 76 is guided together with the first conductive wire 74 to the second side XB (same side) of the tubular film 36 in the first direction X.

The second conductive wire 76 may be guided in the first direction X together with the first conductive wire 74 towards the first end XA of the tubular film 36. In this case, the second conductive wire 76 can be folded back toward the first end XA.

As illustrated in FIG. 4, the temperature detection units 77 and 79 detect the temperature of the tubular film 36. The conductive wires 78 and 80 are guided in the first direction X towards the second end XB of the tubular film 36.

The conductive wires 74, 76, 78, and 80 may be bundled together by tape, film, or other like.

A second connector is fixed to the guided distal ends of the conductive wires 74, 76, 78, and 80. The second connector is connected to the first connector of the bus.

The temperature detection units 73, 75, 77, and 79 are driven by direct current (DC) power in this example.

The temperature switch unit 41 includes a first temperature switch 85, a second temperature switch 86, and a connecting conductive wire 87.

For example, a thermostat is used for the temperature switches 85 and 86. The temperature switches 85 and 86 are disposed at a portion of the heating element group 47 toward the second end XB. The first temperature switch 85 detects the temperature of the first heater 55. The second temperature switch 86 detects the temperature of the third heater 57. The temperature switches 85 and 86 turn power supply on and off based on the detected temperature. Each of the temperature switches 85 and 86 are respectively disposed in one of the through holes 71 of the support member 38. The temperature switches 85 and 86 are each in contact with the heater unit 37.

The connecting conductive wire 87 connects the temperature switches 85 and 86 to each other in series. The first end portion of the connecting conductive wire 87 is connected to the third contact 62. The second end portion of the connecting conductive wire 87 is connected to a power supply 100. For example, the power supply 100 is a commercial 100 V alternating current (AC) power supply. The temperature switches 85 and 86 are driven by AC power.

The temperature switches 85 and 86 detect abnormal heat generation by the heaters 55 and 57. Then, the power to the heating element group 47 is cut off when abnormal heating is detected.

The first end portion of a first connecting conductive wire 101 is connected to the first contact 60. A first triac 102 is provided in the first connecting conductive wire 101. The second end portion of the first connecting conductive wire 101 is connected to the power supply 100.

The first end portion of a second connecting conductive wire 103 is connected to the second contact 61. A second triac 104 is provided in the second connecting conductive wire 103. The second end portion of the second connecting conductive wire 103 is connected to the power supply 100. The triacs (102 and 104) are controlled by the CPU 91.

Here, a method for controlling the amount of electric power supplied to the heating element group 47 will be described using FIG. 4.

The CPU 91 turns on the triacs 102 and 104. Then, the electric power is applied from the power supply 100 to the heaters 55, 56, and 57 through the contacts 60 and 61. Then, the temperature of the heaters 55, 56, and 57 rises. At the nip N, the toner image TI will be heated by the heating element group 47 and fixed to the sheet S, which is pressed by the pressure roller 31.

The potential difference output from the temperature detection units 77 and 79 can be analog-to-digital (A/D) converted by an A/D converter and the digital value supplied to a port of the CPU 91.

Based on the temperature represented by the potential difference, the CPU 91 controls the electric power applied to the heaters 55, 56, and 57 with the triacs 102 and 104 by phase control or frequency control.

By providing the temperature switches 85 and 86, the electric power applied from the power supply 100 to the heating element group 47 can be cut off regardless of the CPU 91 when the temperatures of the heaters 55 and 57 rise abnormally.

Next, the procedure for assembling the temperature detection unit 40 of the fixing device 30 in the manufacturing method of the image forming apparatus 1 configured as described above will be described.

The operator inserts the temperature detection units 73, 75, 77, and 79 of the temperature detection unit 40 from the second end XB into the region surrounded by the tubular film 36. The first temperature detection unit 73 is connected to the holder for the first temperature detection unit 73. Similarly, the second temperature detection unit 75 is connected to the holder for the second temperature detection unit 75. The first conductive wire 74 can be folded back as appropriate. The conductive wires 74, 76, 78, and 80 are guided to the second end XB of the tubular film 36.

The second connector of the temperature detection unit 40 is connected to the first connector of the bus.

Here, the results of comparing the lengths of the conductive wires 74 and 76 between the fixing device 30 of an example (“Example”) according to and embodiment and the fixing device of certain comparative examples (“Comparative Example 1” and “Comparative Example 2”) will be described. As illustrated in FIG. 6, in both the fixing device 30 of an embodiment and the fixing device of the Comparative Example, the distance between the centerline M of the heating element group 47 and the center of the first temperature detection unit 73 (or, alternatively, temperature sensing unit 83) in the first direction X is 145 mm. The distance between the centerline M of the heating element group 47 and the center of the second temperature detection unit 75 in the first direction X is 90 mm.

The measurement results of the lengths of the conductive wires 74 and 76 inside the region surrounded by the tubular film 36 in the fixing device 30 of an embodiment (“Example) are illustrated in Table 1.

TABLE 1

| | Length of conductive wire inside | | |
|---|---|---|---|
| | tubular film | | Difference |
| | Second | First | in length of |
| | conductive | conductive | conductive |
| | wire | wire | wires |
| Example | 263 mm | 372.7 mm | 109.7 mm |
| Comparative | 263 mm | 319.5 mm | 56.5 mm |
| Example 1 | | | |
| Comparative | 322.1 mm | 319.5 mm | 2.6 mm |
| Example 2 | | | |

As illustrated in Table 1, in the fixing device 30 (“Example”), the length of the first conductive wire 74 inside the tubular film 36 was 372.7 mm. The length of the second conductive wire 76 inside the tubular film 36 was 263 mm. The difference in length of the conductive wires 74 and 76 was 109.7 mm (from the difference (372.7−263)).

FIG. 8 illustrates a fixing device 110 of Comparative Example 1. In the fixing device 110, the first conductive wire 74 is connected to the first temperature detection unit 73 on the second end XB of the first temperature detection unit 73. Thus, in the fixing device 110, the first conductive wire 74 is not folded back inside the tubular film 36.

As illustrated in Table 1, in the fixing device 110 of Comparative Example 1, the length of the first conductive wire 74 inside the tubular film 36 was 319.5 mm. The length of the second conductive wire 76 inside the tubular film 36 was 263 mm. The difference in length of the conductive wires 74 and 76 was 56.5 mm (from the difference (319.5−263)).

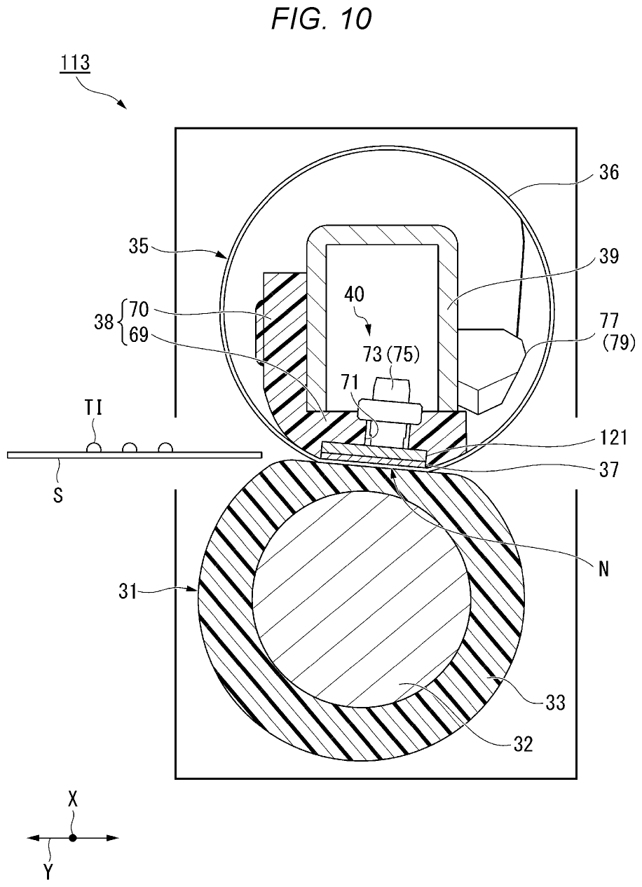

FIG. 9 illustrates a fixing device 111 of Comparative Example 2. In the fixing device 111, the second conductive wire 76 is connected to the second temperature detection unit 75 on the first end XA of the second temperature detection unit 75. In the fixing device 111, the second conductive wire 76 is thus folded (bent) back toward the second end XB.

As illustrated in Table 1, in the fixing device 111 of Comparative Example 2, the length of the first conductive wire 74 in the tubular film 36 was 319.5 mm. The length of the second conductive wire 76 in the tubular film 36 was 322.1 mm. The difference in length of the conductive wires 74 and 76 was 2.6 mm (from the difference (322.1−319.5)).

The difference in length of the conductive wires 74 and 76 in the fixing device 30 of an embodiment (“Example”) is greater than the differences in length of the conductive wires 74 and 76 in the fixing devices 110 and 111 of Comparative Example 1 and Comparative Example 2.

As described above, in the fixing device 30 of this present embodiment, the conductive wires 74 and 76 are connected to the temperature detection units 73 and 75 from opposite ends in the first direction X of the temperature detection units 73 and 75, respectively. The first conductive wire 74 is folded back toward the second end XB, and the conductive wires 74 and 76 are guided to (led out to in the first direction X) the second end XB of the tubular film 36. Therefore, the length of the first conductive wire 74 will be longer than the length of the second conductive wire 76 by at least a predetermined length inside the tubular film 36. The predetermined length here will be the sum of the pitch PA between the temperature detection units 73 and 75 and the length required to fold back the first conductive wire 74, as illustrated in FIG. 6 (the length of the first conductive wire 74 in the area R). In this case, the difference in required length of the conductive wires 74 and 76 disposed inside the tubular film 36 will be sufficiently large to be noticeable during assembly as compared to the fixing devices 110 and 111 of comparative examples (Comparative Example 1 and Comparative Example 2).

For example, the length of the second conductive wire 76 is sufficiently less than the length of the first conductive wire 74 that while the operator could connect the second temperature detection unit 75 to the holder for the first temperature detection unit 73, if the first temperature detection unit 73 is mistakenly connected to the holder for the second temperature detection unit 75, the operator will eventually notice that the connection has been mistakenly made since the length of the first conductive wire 74 will be noticeably excessive inside the tubular film 36. Therefore, it is possible to prevent the temperature detection units 73 and 75 from being attached to the wrong positions.

The first temperature detection unit 73 is disposed at an end portion on the first end XA of the heating element group 47, and the second temperature detection unit 75 is disposed at the center portion of the heating element group 47. For example, the temperature detection units 73 and 75, which are driven by DC power, are arranged closer to the first end XA. Accordingly, it is possible to make less likely to interfere with the connecting of conductive wires 87 for the temperature switches 85 and 86, which are driven by AC power, and the conductive wires 74 and 76 for the temperature detection units 73 and 75.

The temperature detection units 73 and 75 have the same configuration as each other in this example. This configuration can reduce the manufacturing cost of the fixing device 30.

The fixing device 30 of the present embodiment can be variously modified as described below.

In addition to each configuration of the fixing device 30 of this embodiment, a high heat conduction member 121 may be provided, as in a fixing device 113 of a first modification illustrated in FIG. 10.

The high heat conduction member 121 is formed of a metal material such as aluminum or copper, or a graphite sheet, which has a higher heat conductivity than that of the substrate 45, in a shape of an elongated rectangular plate. The high heat conduction member 121 extends in the first direction X. The high heat conduction member 121 is disposed between the first member 69 of the support member 38 and the heater unit 37. The high heat conduction member 121 is likely to transfer heat in the first direction X and the like.

The first temperature detection unit 73 and the second temperature detection unit 75 are respectively fixed to the heater unit 37 (more particularly, the heating element group 47 in this example) via the high heat conduction member 121.

The fixing device 113 of the first modification includes a high heat conduction member 121. Therefore, the temperature gradient along the first direction X for the tubular film 36 and the heater unit 37 (heating element group 47) can be reduced. Therefore, it is possible to suppress a local temperature increase in a portion of the heater unit 37.

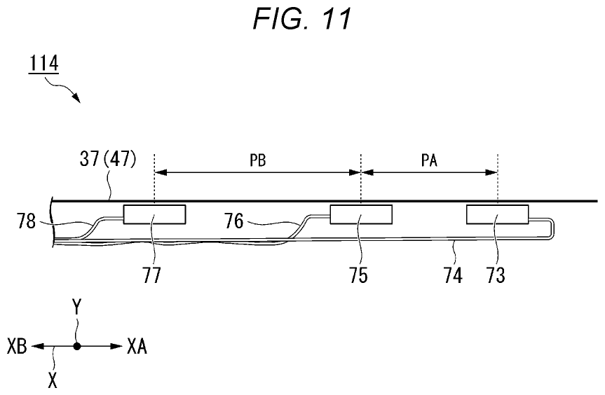

As illustrated in a second modification in FIG. 11, a fixing device 114 may include the temperature detection units 73, 75, and 77 arranged side by side in the first direction X. The temperature detection units 73, 75, and 77 are arranged in this order from the first end XA to the second end XB.

The plurality of pitches PA and PB are formed by a pair of temperature detection units that are adjacent to each other in the first direction X, among the temperature detection units 73, 75, and 77. Specifically, the pitch PA is formed by the first temperature detection unit 73 and the second temperature detection unit 75. The pitch PB is formed by the second temperature detection unit 75 and the third temperature detection unit 77. The pitch PA is shorter than the pitch PB. That is, the shortest pitch among the plurality of pitches PA and PB is the pitch PA. The pair of temperature detection units that form the pitch PA are the first temperature detection unit 73 and the second temperature detection unit 75.

In the fixing device 114 of the second modification, the conductive wires 74 and 76 are respectively connected to the temperature detection units 73 and 75 that form the shortest pitch PA, from the outside in the first direction X. The conductive wires 74 and 76 are led out in the first direction X to the second end XB of the tubular film 36. Therefore, it is possible to prevent the temperature detection units 73 and 75 from being attached to the wrong positions. In the second modification, the third conductive wire 78 is connected to the third temperature detection unit 77 from the second end XB of the third temperature detection unit 77 and is guided in the first direction X to the second end XB of the tubular film 36. However, the third conductive wire 78 may be connected to the third temperature detection unit 77 from the first end XA of the third temperature detection unit 77. In this case, the third conductive wire 78 is folded (bent) back toward the second end XB and is guided in the first direction X to the second end XB of the tubular film 36.

Since the pitch PB is longer than the pitch PA, the temperature detection units 75 and 77 can be prevented from being attached to the wrong positions.

For these reasons, it is possible to prevent the temperature detection units 73, 75, and 77 from being attached to the wrong positions.

In some examples, the fixing device 30 may include four or more temperature detection units arranged in a row along the first direction X.

In this embodiment, the temperature detection units 73 and 75 may be arranged to the second end XB side of the heating element group 47. The temperature detection units 73, 75, 77, and 79 may be configured differently from each other in some examples.

The fixing device 30 need not necessarily include the support member 38, the stay 39, and the temperature switch unit 41. The heater unit 37 may be comprised of only the heating element group 47.

The heaters 55, 56, and 57 may be integrally formed with one another. The temperature detection unit 40 may not always include the temperature detection units 77 and 79 and the conductive wires 78 and 80.

The heating device of the example embodiments was assumed to be a fixing device for a printer or the like. However, the heating device of the present disclosure is not limited to a fixing device and may be, for example, incorporated as a decoloring device. A decoloring device decolors the image formed on a sheet S using a decolorable toner.

According to at least one of the above-described embodiments, by providing the temperature detection units 73 and 75 and the conductive wires 74 and 76, it is possible to prevent the temperature detection units 73 and 75 from being attached to the wrong positions during manufacturing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A heating device, comprising:
a tubular body;
a heater disposed within an interior region surrounded by the tubular body;
a first temperature detection unit disposed within the interior region;
a first conductive wire connected to the first temperature detection unit on a first side of the first temperature detection unit facing a first direction parallel to the axial length of the tubular body;
a second temperature detection unit disposed within the interior region on a second side of the first temperature detection unit opposite the first side, the second temperature detection unit being spaced from the first temperature detection unit in a second direction opposite of the first direction; and
a second conductive wire connected to the second temperature detection unit on a side of the second temperature detection unit facing the second direction, wherein
the first conductive wire and the second conductive wire extend with each other in the second direction to an outer end of the tubular body in the second direction.

2. The heating device according to claim 1, wherein
the first temperature detection unit is disposed at an outer end portion of the heater, and
the second temperature detection unit is disposed at a center portion of the heater.

3. The heating device according to claim 1, wherein the first temperature detection unit and the second temperature detection unit have the same configuration.

4. The heating device according to claim 1, further comprising:
a heat conduction member affixed to a surface of the heater, wherein
the first temperature detection unit contacts the heater via the heat conduction member.

5. The heating device according to claim 1, further comprising:
a third temperature detection unit disposed within the interior region.

6. The heating device according to claim 5, wherein the second temperature detection unit is between the third temperature detection unit and the first temperature detection unit in the first direction.

7. The heating device according to claim 6, wherein a spacing between the first and second temperature detection units is different than a spacing between the second and third temperature detection units.

8. The heating device according to claim 7, wherein the spacing between the first and second temperature detection units is less than the spacing between the second and third temperature detection units.

9. The heating device according to claim 1, wherein the first temperature detection unit is a thermistor.

10. The heating device according to claim 9, wherein the second temperature detection unit is another thermistor.

11. The heating device according to claim 1, wherein the second temperature detection unit is a thermistor.

12. The heating device according to claim 1, wherein the first and second conductive wires have different lengths.

13. An image processing apparatus, comprising:
an image forming unit configured to form a toner image on a sheet;
a fixing device configured to receive the sheet from the image forming unit and fix the toner image to the sheet with heat from a heating device, the heating device including:
a tubular body;
a heater disposed within an interior region surrounded by the tubular body;
a first temperature detection unit disposed within the interior region;
a first conductive wire connected to the first temperature detection unit on a first side of the first temperature detection unit facing a first direction parallel to the axial length of the tubular body;
a second temperature detection unit disposed within the interior region on a second side of the first temperature detection unit opposite the first side, the second temperature detection unit being spaced from the first temperature detection unit in a second direction opposite of the first direction; and
a second conductive wire connected to the second temperature detection unit on a side of the second temperature detection unit facing the second direction, wherein
the first conductive wire and the second conductive wire extend with each other in the second direction to an outer end of the tubular body in the second direction.

14. The image forming apparatus according to claim 13, wherein
the first temperature detection unit is disposed at an outer end portion of the heater, and
the second temperature detection unit is disposed at a center portion of the heater.

15. The image forming apparatus according to claim 13, further comprising:
a heat conduction member affixed to a surface of the heater, wherein
the first temperature detection unit contacts the heater via the heat conduction member.

16. The image forming apparatus according to claim 13, wherein
the heater further includes:
a third temperature detection unit disposed within the interior region,
the second temperature detection unit is between the third temperature detection unit and the first temperature detection unit in the first direction, and
a spacing between the first and second temperature detection units is less than a spacing between the second and third temperature detection units.

17. The image forming apparatus according to claim 13, wherein
the first temperature detection unit is a thermistor, and
the second temperature detection unit is another thermistor.

18. The image forming apparatus according to claim 13, wherein the first and second conductive wires have different lengths.

19. A fixing device for fixing a toner image to a sheet, the fixing device comprising:
a cylindrical belt;
a heater disposed within an interior region surrounded by the cylindrical belt;
a first temperature sensor disposed within the interior region;
a first conductive wire connected to the first temperature sensor on a first side of the first temperature sensor facing a first direction parallel to the axial length of the cylindrical belt;
a second temperature sensor disposed within the interior region on a second side of the first temperature sensor opposite the first side, the second temperature detection unit being spaced from the first temperature sensor in a second direction opposite of the first direction; and
a second conductive wire connected to the second temperature sensor on a side of the second temperature detection unit facing the second direction, wherein
the first conductive wire and the second conductive wire extend with each other in the second direction to an outer end of the cylindrical belt in the second direction.

20. The fixing device according to claim 19, wherein the first and second conductive wires have different lengths inside the interior region.
